(19) United States
(12) Patent Application Publication
(10) Pub. No.: US 2026/0110217 A1
(43) Pub. Date: Apr. 23, 2026

(54) LADDER TOP CAP BUCKET

(71) Applicant: Tricam Industries, Inc., Eden Prairie, MN (US)

(72) Inventors: Joseph P. Foley, Mendota Heights, MN (US); Marie A. Vanderwarn, Minneapolis, MN (US)

(73) Assignee: Tricam Industries, Inc., Eden Prairie, MN (US)

(21) Appl. No.: 18/918,559

(22) Filed: Oct. 17, 2024

(51) Int. Cl. E06C 7/14; E06C 1/32

(52) U.S. Cl. CPC E06C 7/14; E06C 1/32

(57) ABSTRACT

A bucket for a ladder is disclosed. The bucket provides an area for workspace or for storage of tools or materials in addition to that provided by the ladder by itself. The bucket is configured to be removably attachable to the top of the ladder when in use or removably attached to the ladder and preferably within the boundaries of the ladder when not in use.

### FIELD OF THE INVENTION

The present invention relates to a detachable bucket for use with a ladder that provides additional space at the top of the stepladder but may be conveniently stored within the boundaries of the ladder when not in use.

### BACKGROUND OF THE INVENTION

It is often inconvenient, however, to use a removable tool or paint tray with a ladder. In some instances, the tray may be difficult to attach or remove from the ladder depending on the configuration of the top cap of the ladder. The removable tray and ladder usually must be stored separately, taking up additional space. Additionally, to move a ladder from place to place, the tray may need to be removed and carried separately because of weight or awkward transport configuration.

Ladders, step stools, and stepladders are generally known in the art. Kummerlin, U.S. Pat. No. 4,502,564, discloses a foldable step ladder. Because of their desired portability, foldable stepladders often include handles and other features that make them easier to transport. Lucci, U.S. Pat. No. 3,744,591, discloses a portable, folding stepladder.

When working on a ladder, step stool, or stepladder, it is often desirable to have tools, paint, and other necessary objects within easy reach. For example, it is known to removably attach a paint roller tray to the rung of a ladder to more easily paint a ceiling or other area requiring a ladder. Golden, U.S. Pat. No. 3,625,388, discloses a paint tray particularly useful with an upright ladder. Utility trays for use with ladder, step stool, or stepladder are also known in the art. Pham, U.S. Pat. No. 5,673,885, discloses a paint tray for a stepladder for storing work materials, tools and a paint bucket that is held onto the stepladder by retaining means. Melanson, U.S. Pat. No. 5,613,574, discloses a stepladder mounted tool holster and parts tray that removably clamps onto the top step of a stepladder. Katz et al., U.S. Pat. No. 6,443,260, discloses a stepladder tray pivotally attached to the top cap of a stepladder for supporting tools and the like. Christ et al., U.S. Pat. No. 5,052,581, discloses a detachable ladder support tray for supporting tools and paint containers. Improvements to add to the amount of space available at the top of a stepladder include U.S. Pat. No. 10,138,680 to Williams, et al., for a hinged tray for a ladder or step stool.

Ladder trays and buckets are known, including those disclosed in U.S. Pat. Nos. 3,625,388 to Golden; 5,052,581 to Christ et al.; 5,613,574 to Melanson; 5,673,885 to Pham; 6,443,260 to Katz et al.; U.S. patent application No. US14/207,887 to Najey (Published as U.S. Pub. No. US20140326538A1); U.S. Pat. Nos. 9,714,542 to Harcz; 7,886,872 to Astor et al.; 8,453,796 to Astor et al.; 7,128,187 to Simpson; 7,188,706 to Simpson; 10,138,680 to Williams et al.; U.S. Patent No. D833,643 to Foley et al; as well as U.S. patent application Ser. No. 16/654,699 to Foley et al. patented as U.S. Patent No. 11,505,994); U.S. patent application Ser. No. 16/715,097 to Foley (published as US20200190905 A1); U.S. patent application Ser. No. 16/788,655 to Wernberg, et al. (published as U.S. Pub. No. US20210246725 A1), and U.S. patent application Ser. No. 17/130,414 to Foley et al. (published as U.S. Pub. No. US20220195800 A1), all of which are incorporated herein by reference.

There is a need in the industry to have a bucket that can be removably attached to a ladder to hold tools and hardware but can be removed and stored more easily within the boundaries of the ladder and not interfere with the other functionality of the ladder whether in-use or stored..

### SUMMARY OF THE INVENTION

The ladder top cap bucket of the present invention provides an increased work area at the top of the ladder without increasing the overall size of the ladder when in the stored position. In embodiments, a detachable bucket for a ladder is disclosed. The bucket allows for a larger work area on the top of a ladder while the bucket can be removed and stored within the boundaries of the closed ladder. The bucket provides a more easily accessible and easier to store/remove work and storage area than prior art ladder trays without increasing storage space requirements. The bucket can still be used as a work area for holding tools and hardware when the ladder is in the in-use or closed orientations. The bucket includes prongs that fit into prong slots on the top cap of the ladder to easily secure the tray to the top cap and to remove the bucket from the top cap when not in use. The bucket is also configured to mate its back wall with the front wall of the top cap to provide a more secure and stronger joining of the two to prevent inadvertent dislodging and for the bucket to carry more weight. The invention also includes clips that are sized to mate with receivers on the rails of the ladder to easily secure and install the bucket to the ladder rails. The clips and receivers are sized configured to securely hold the bucket in place while stored and not interfere with a user climbing on the ladder. While the preferred embodiment uses prongs on the bucket with prong slots on the top cap, the bucket can be removably attached and detached to both the top cap for use and to the ladder for storage by any means known in the art.

It is an object of the invention to provide a removable bucket for the top of a ladder. It is another object of the invention to provide a bucket that does not increase the footprint of the ladder to eliminate any impact on storing of the ladder having the utility of bucket. It is a further object of the invention to provide access to the bucket at the top of the ladder, step stool, or stepladder without having to reach over and beyond the top of the ladder. Another object of the invention is to more securely hold the bucket in the stored position.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 depicts a perspective view of an embodiment of the ladder top cap bucket.

FIG. 2 depicts a second perspective view of the ladder top cap bucket of FIG. 1.

FIG. 3 depicts a front elevation view of the ladder top cap bucket of FIG. 1.

FIG. 4 depicts a rear elevation view of the ladder top cap bucket of FIG. 1.

FIG. 5 depicts a left-side view of the ladder top cap bucket of FIG. 1.

FIG. 6 depicts a right-side view of the ladder top cap bucket of FIG. 1.

FIG. 7 depicts a top plan view of the ladder top cap bucket of FIG. 1.

FIG. 8 depicts a bottom plan view of the ladder top cap bucket of FIG. 1.

FIG. 9 depicts a cross-sectional view taken along the line A-A in FIG. 3.

FIG. 10 depicts a cross-sectional view taken along the line B-B in FIG. 5.

FIG. 11 depicts a perspective view of a multi-position ladder including a top cap and in the closed/stored orientation with an embodiment of the ladder top cap bucket of FIG. 1.

FIG. 12 depicts a front elevation view of the multi-position ladder of FIG. 11.

FIG. 13 depicts a rear elevation view of the multi-position ladder of FIG. 11.

FIG. 14 depicts a left-side view of the multi-position ladder of FIG. 11.

FIG. 15 depicts a right-side view of the multi-position ladder of FIG. 11.

FIG. 16 depicts a top plan view of the multi-position ladder of FIG. 11.

FIG. 17 depicts a bottom plan view of the multi-position ladder of FIG. 11.

FIG. 18 depicts a cross-sectional view taken along the line C-C in FIG. 13.

FIG. 19 depicts a perspective view of a multi-position ladder including a top cap in an open/in-use orientation with an embodiment of the ladder top cap bucket of FIG. 1 in the use position.

FIG. 20 depicts a front elevation view of the multi-position ladder of FIG. 19.

FIG. 21 depicts a rear elevation view of the multi-position ladder of FIG. 19.

FIG. 22 depicts a left-side view of the multi-position ladder of FIG. 19.

FIG. 23 depicts a right-side view of the multi-position ladder of FIG. 19.

FIG. 24 depicts a top plan view of the multi-position ladder of FIG. 19.

FIG. 25 depicts a bottom plan view of the multi-position ladder of FIG. 19.

FIG. 26 depicts a close-up view within the arc D-D in FIG. 21.

FIG. 27 depicts a cross-sectional view taken along the line E-E in FIG. 21.

FIG. 28 depicts a perspective view of a multi-position ladder including a top cap in an open/in-use orientation with an embodiment of the ladder top cap bucket of FIG. 1 in the stored position.

FIG. 29 depicts a front elevation view of the multi-position ladder of FIG. 28.

FIG. 30 depicts a rear elevation view of the multi-position ladder of FIG. 28.

FIG. 31 depicts a left-side view of the multi-position ladder of FIG. 28.

FIG. 32 depicts a right-side view of the multi-position ladder of FIG. 28.

FIG. 33 depicts a top plan view of the multi-position ladder of FIG. 28.

FIG. 34 depicts a bottom plan view of the multi-position ladder of FIG. 28.

FIG. 35 depicts a top plan view of a ladder top cap with an embodiment of the ladder top cap bucket of FIG. 1.

FIG. 36 depicts an exploded perspective view of the of the ladder top cap and top cap bucket of FIG. 35.

FIG. 37 depicts a left-side view of a ladder top cap with an embodiment of the ladder top cap bucket of FIG. 36

FIG. 38 depicts a second exploded perspective view of the ladder top cap and top cap bucket of FIG. 35.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The preferred embodiment for the improved ladder bucket is constructed of a single piece of polypropylene injection molded to provide the intricate detailing and varying thickness of the bucket. However, other embodiments may be made of any materials or formed by any methods known in the art. The bucket of the present invention is intended for use with folding ladders or multi-position ladders that have a top cap. While the disclosed bucket could be used with non-folding ladders, the benefits of the present invention such as depth or storage capability would be limited.

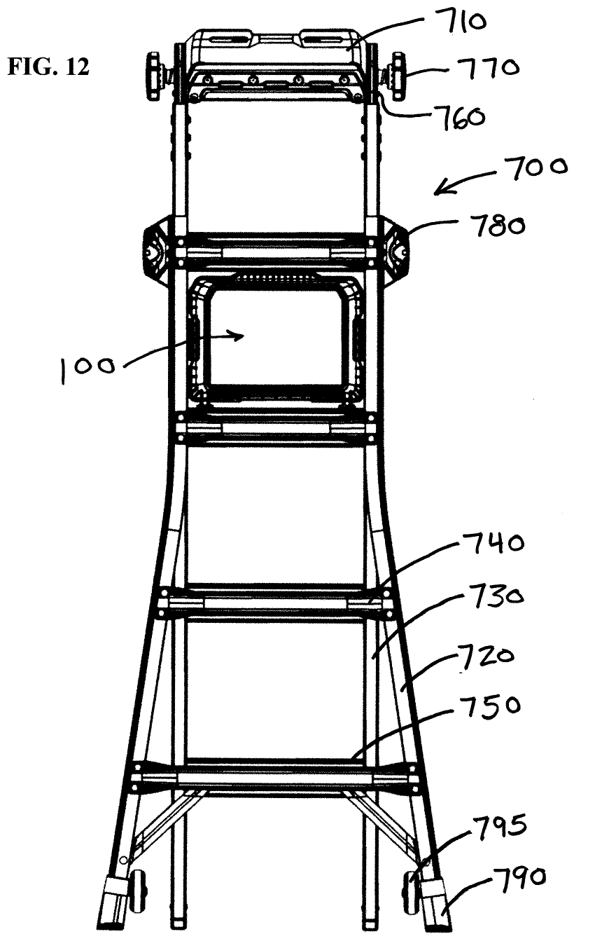

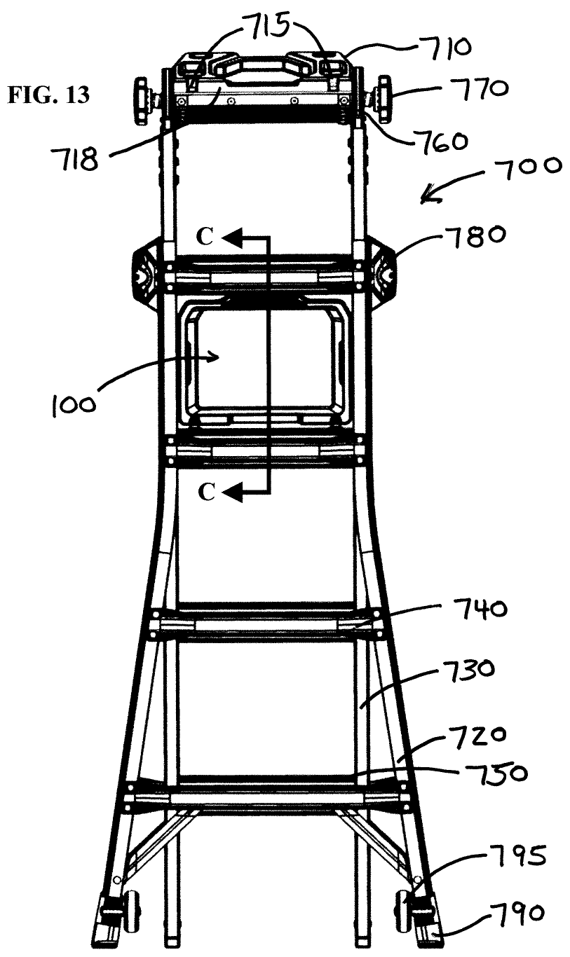

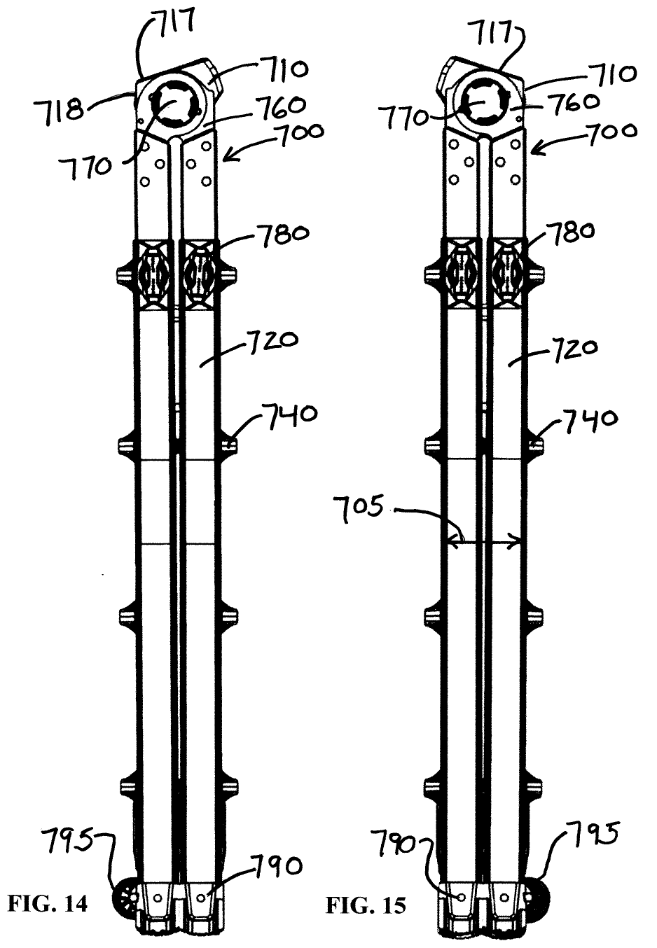

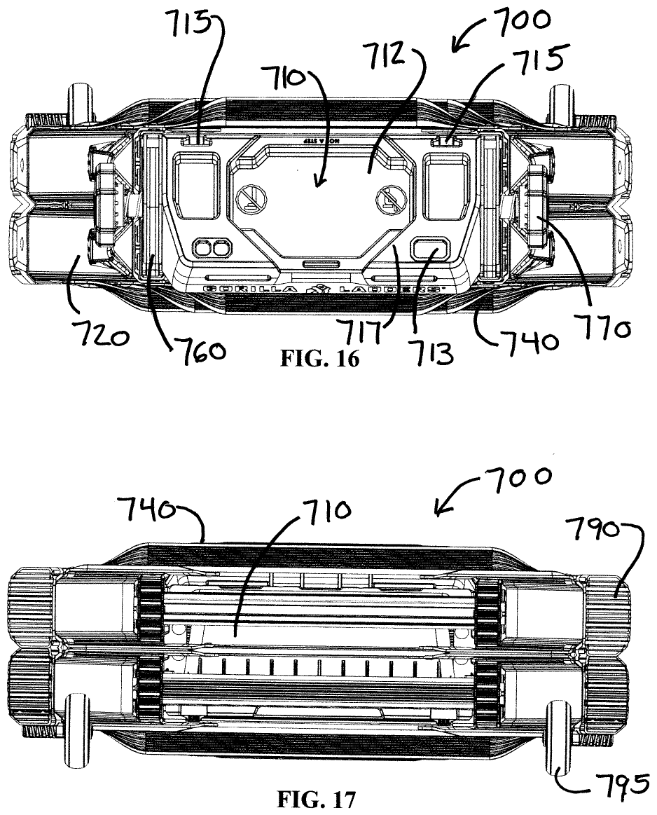

A typical prior-art multi-position ladder incorporating the ladder bucket of the present invention is disclosed FIGS. 11-19. A multi-position ladder 700 will conventionally include four inner rails 730 connected in pairs by a hinge 760 that is adjustable via a hinge lock 770 that allows each pair of outer rails 730 to rotate and vary the angle between the outer rails 730. Adjustably slidable to each inner rail 730 is an outer rail 720 for which an extension lock 780 allows the outer rails 720 to slide along the inner rails 730 to adjust the overall height of the ladder 700. Between the pairs of outer rails 720 are outer rail rungs 740 preferably attached to the outer faces of the outer rails 720 and between the pairs of inner rails 730 are inner rail rungs 750 that preferably are within the profile of the inner rails 730. This arrangement allows each side of the ladder 700 to be independently adjustable in length for varied uses (such as on stairs). Other features that are commonly found on multi-position ladders include a foot 790 at the end of each outer rail 720 and wheels 795 that allow for easier transport of the ladder 700.

A recent improvement to multi-position ladders is the inclusion of a top cap 710, which have been common to standard A-frame ladders. One recent example of such a top cap 710 is disclosed in U.S. Pat. No. 11,505,994, incorporated herein by reference. Multi-position ladders top caps 710 provide a rigid frame between hinges 760 for strength and stability as well as a work surface (top cap upper surface 717) and tool or material storage areas (top cap compartment 712 and top cap orifice 713). The present invention provides an improvement of a ladder top cap bucket 100 that is removably attachable to the ladder top cap 710 for use and storable on the ladder inner rails 730 when not in use.

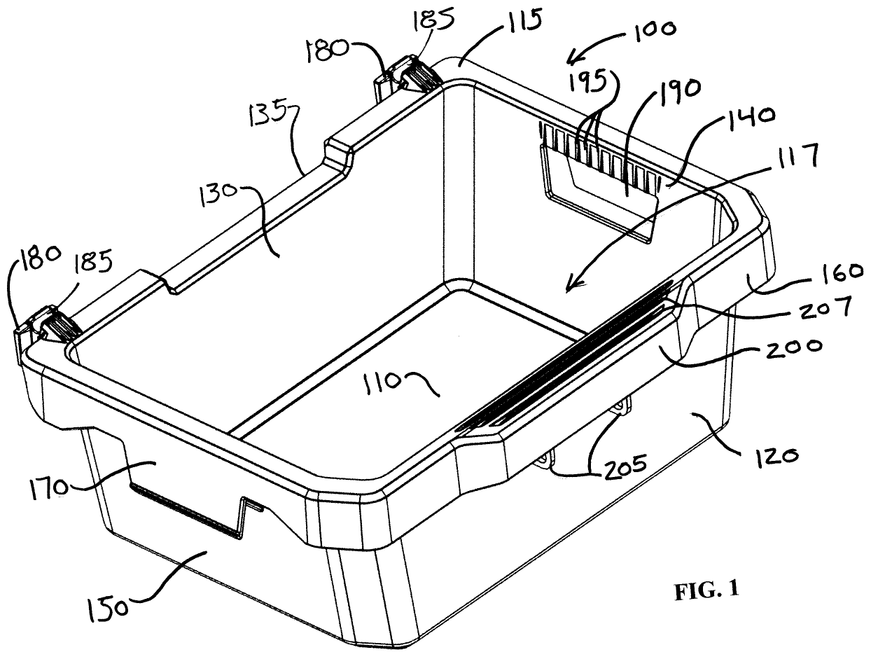

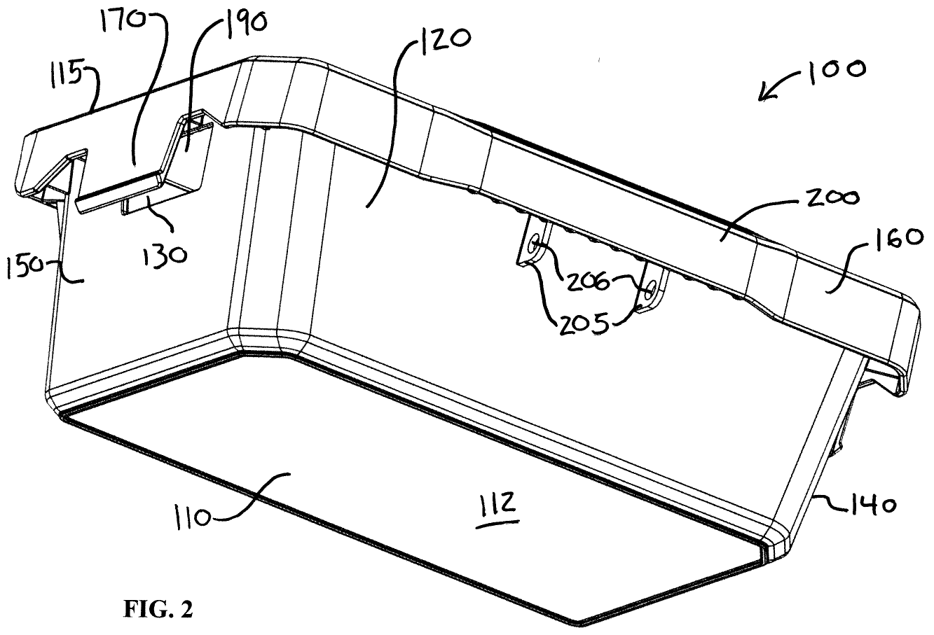

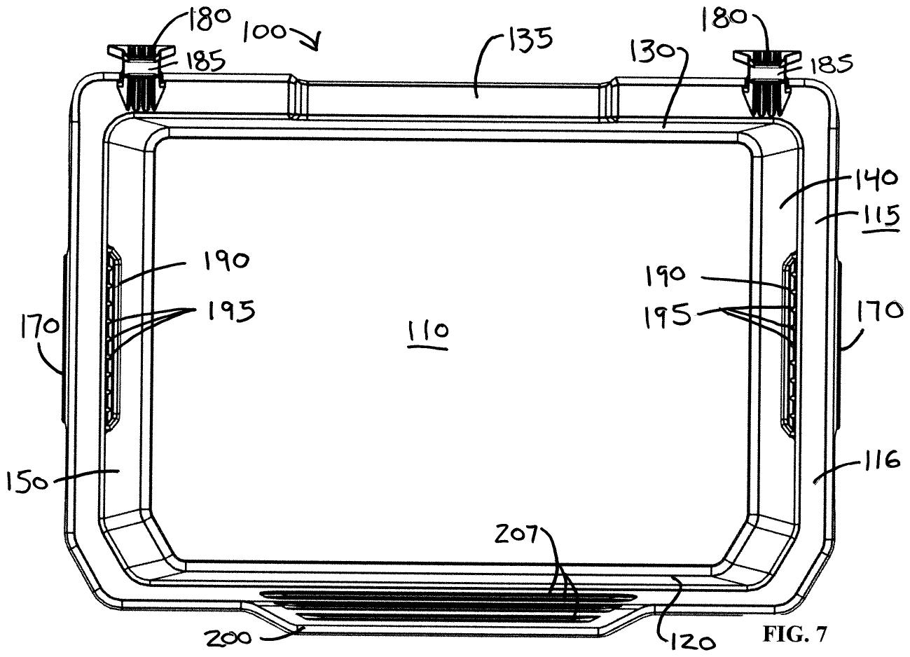

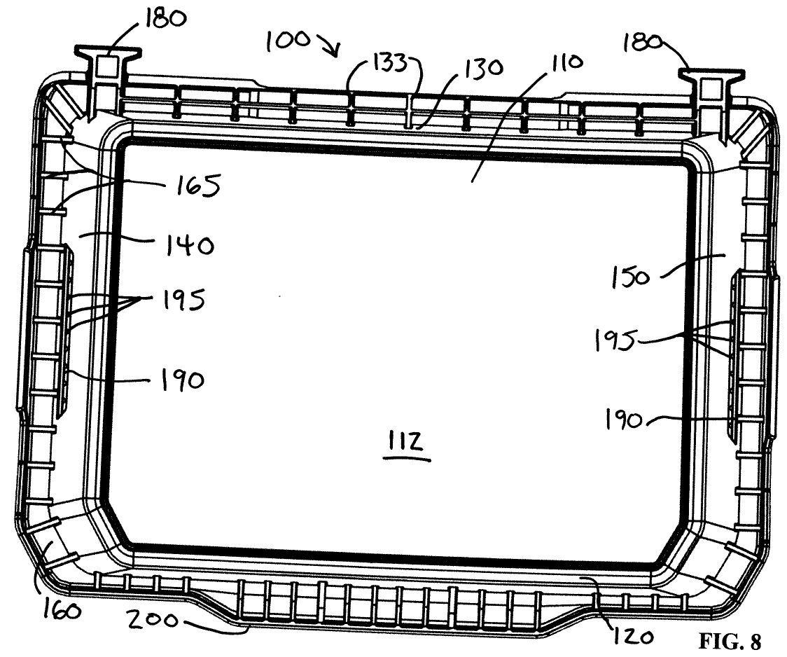

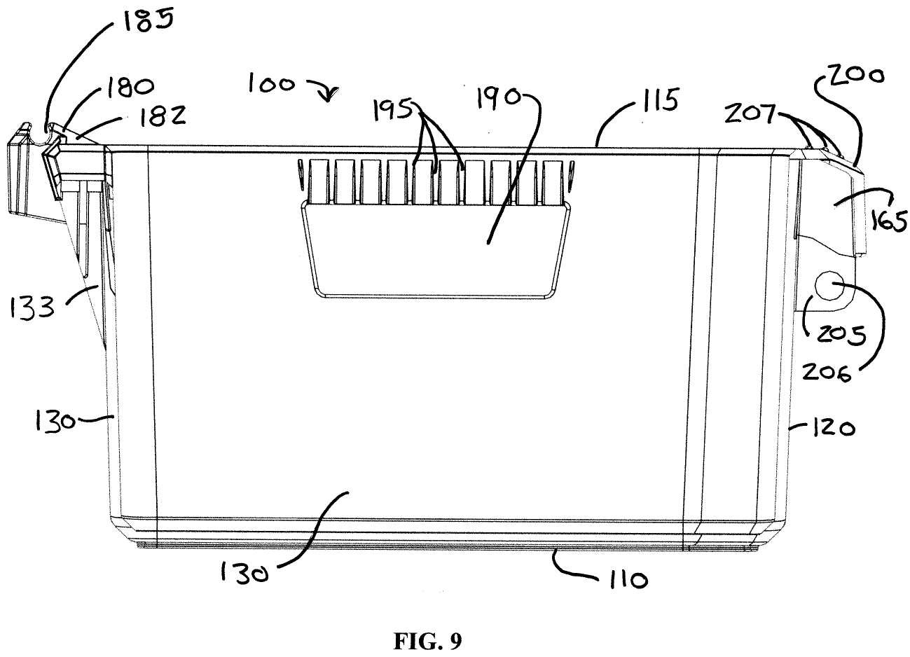

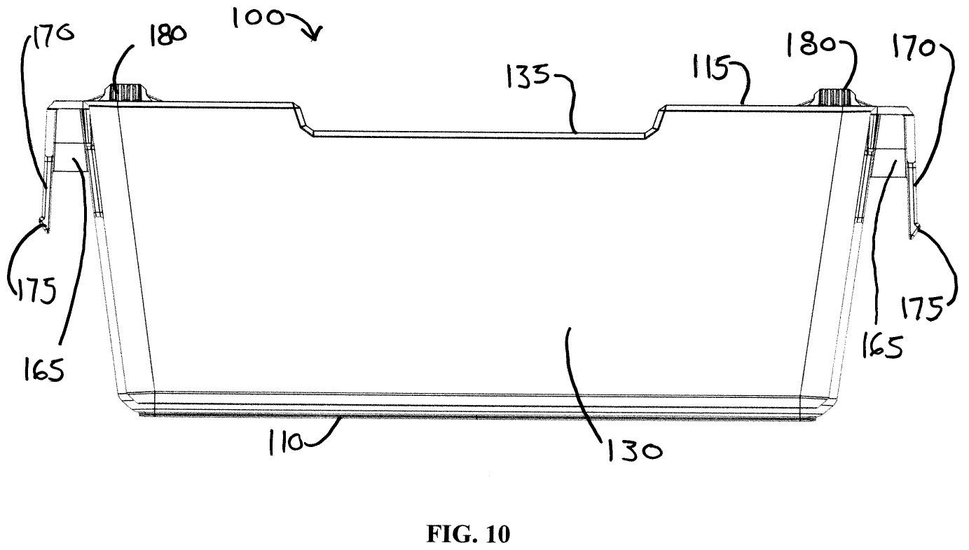

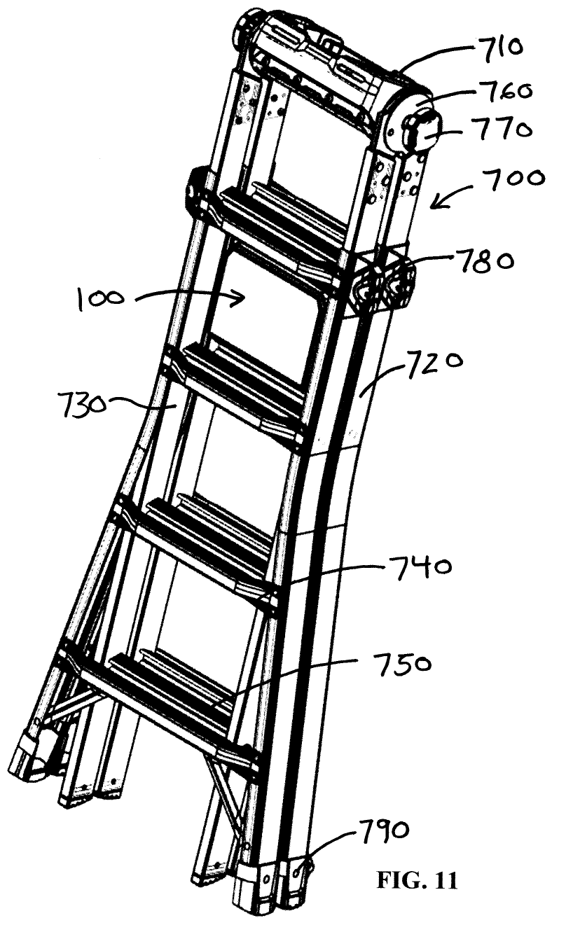

A ladder top cap bucket 100 in accordance with the present invention is illustrated in detail by FIGS. 1-10. The bucket 100 has a front wall 120, a rear wall 130, a right side wall 140, a left side wall 150 and a bottom 110 forming a bucket interior volume 117. The top of the front wall 120, rear wall 130, right side wall 140, and left side wall 150 define a bucket top surface 115 while the outer face of the bottom 110 defines a bucket bottom outer surface 112. The top surface 115 and bottom outer surface 112 define a bucket depth 105.

Along the upper edge of the top of the front wall 120, rear wall 130, right side wall 140, and left side wall 150 is formed a bucket lip 160 that provides both strength and rigidity to the upper portion of the bucket 100 as well as a gripping area around the exterior of the bucket 100. Bucket lip ribs 165 span the interior of the bucket lip 160 for strength and stability of the lip 160.

One embodiment of the present invention includes a bucket front handle 200 formed in the lip 160 on the front wall 120 of the bucket 100. The front handle 120 may also include handle ridges 207 that provide a gripping surface for handling the bucket 100. The handle ridges 207 may be formed in the front handle 120 or added by means known in the art. The bucket front wall 120 may also include hangers 205 with respective hanger orifices 206 that provide means to hang tools, equipment, or other items while the bucket 100 is in use. The bucket rear wall 130 may also include a wall notch 135 that aligns with a respective notch on the top cap 710 when the bucket 100 is in the use position to allow access between the two below the bucket top surface 115 and top cap upper surface 717.

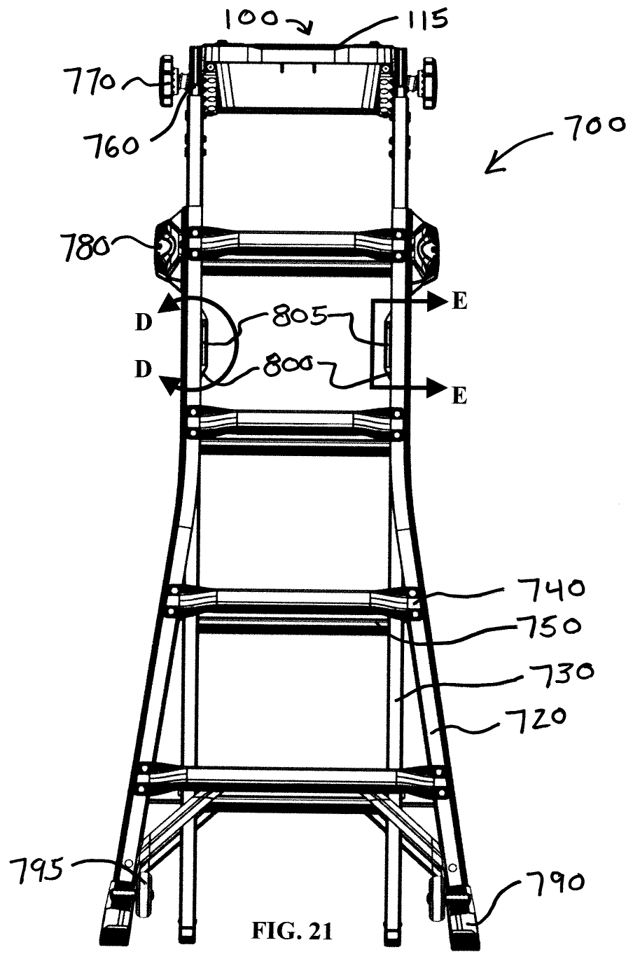

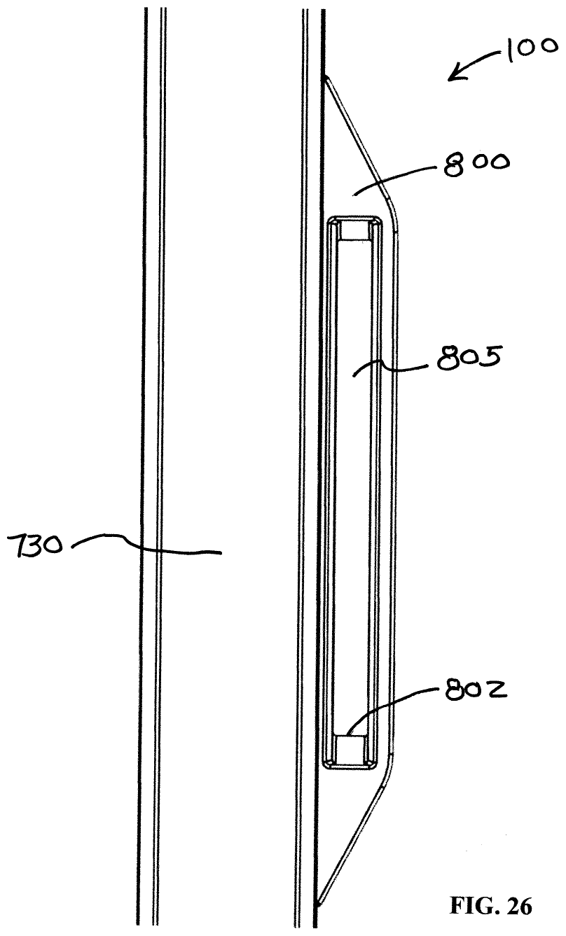

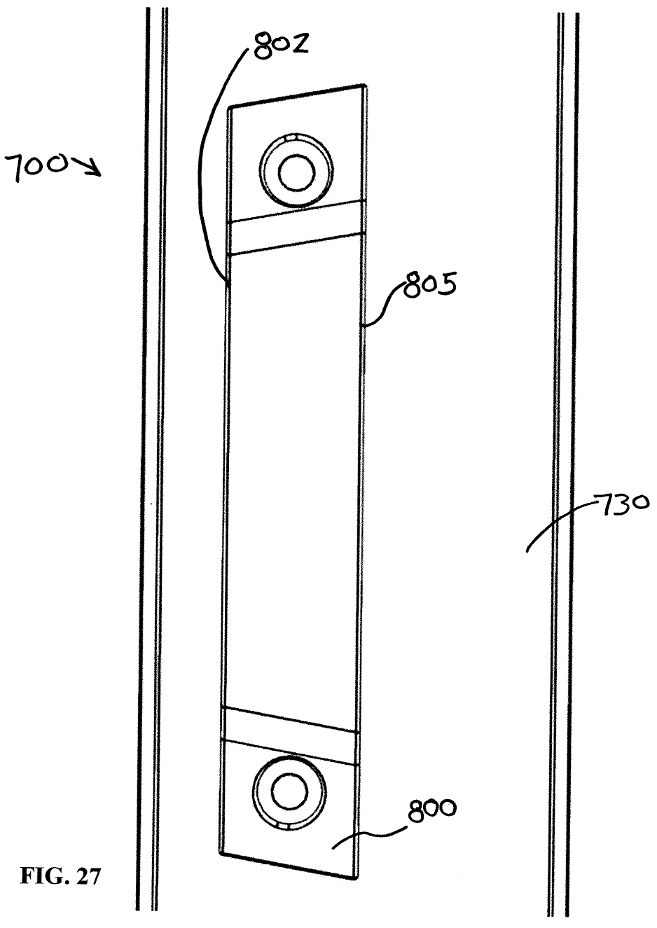

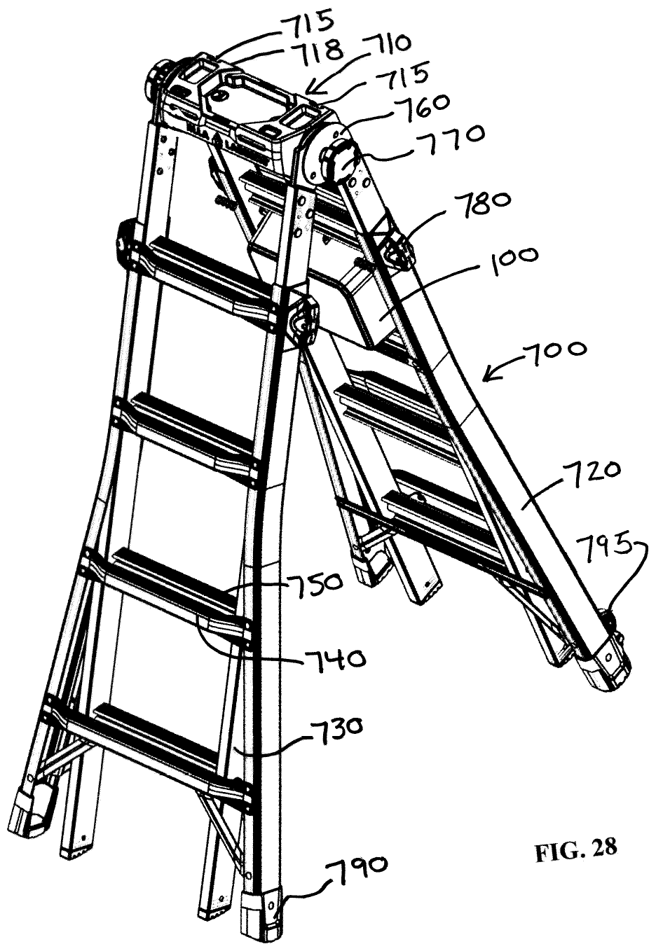

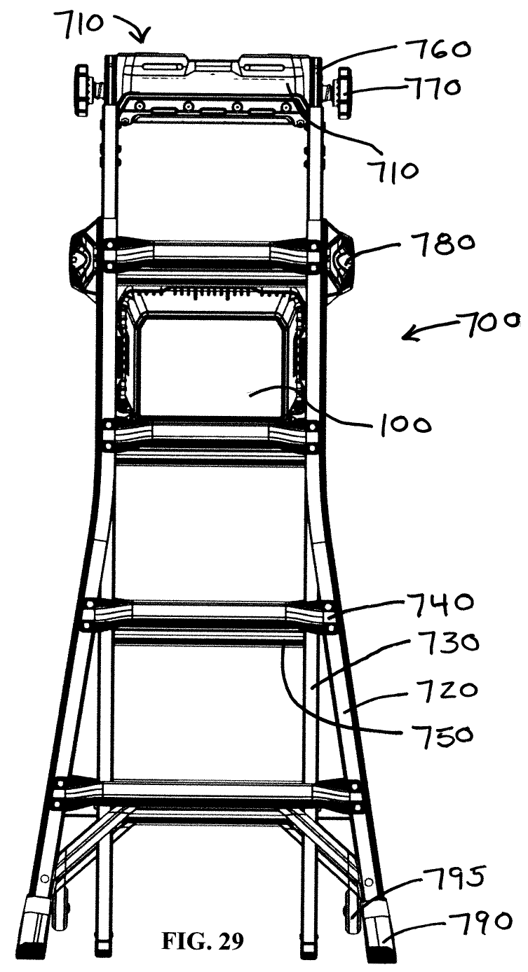

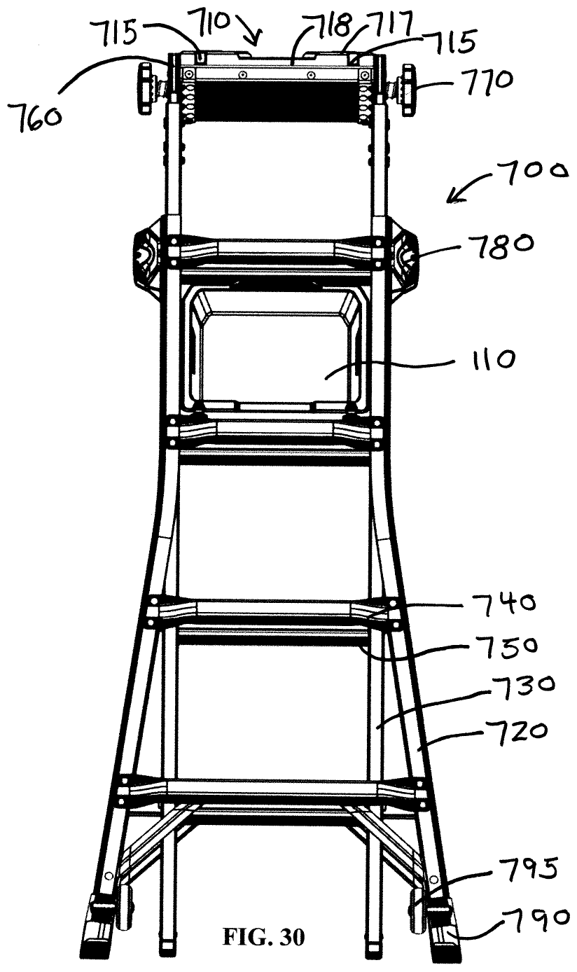

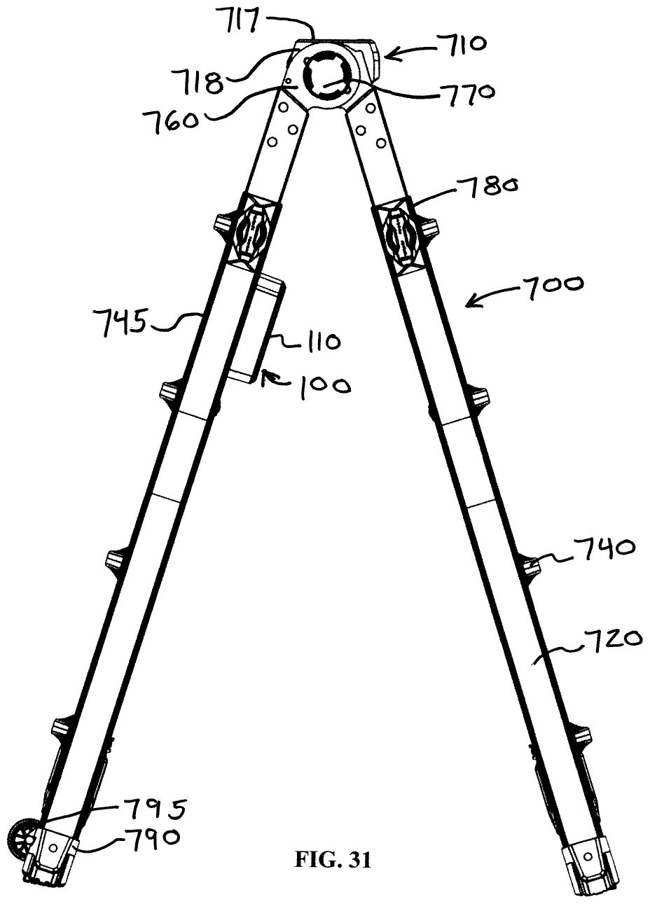

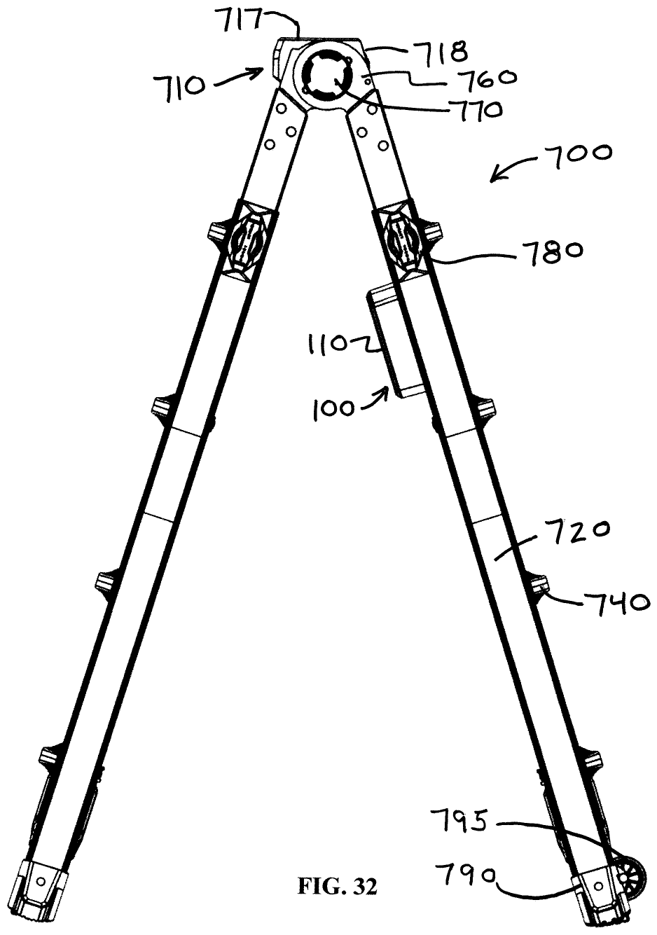

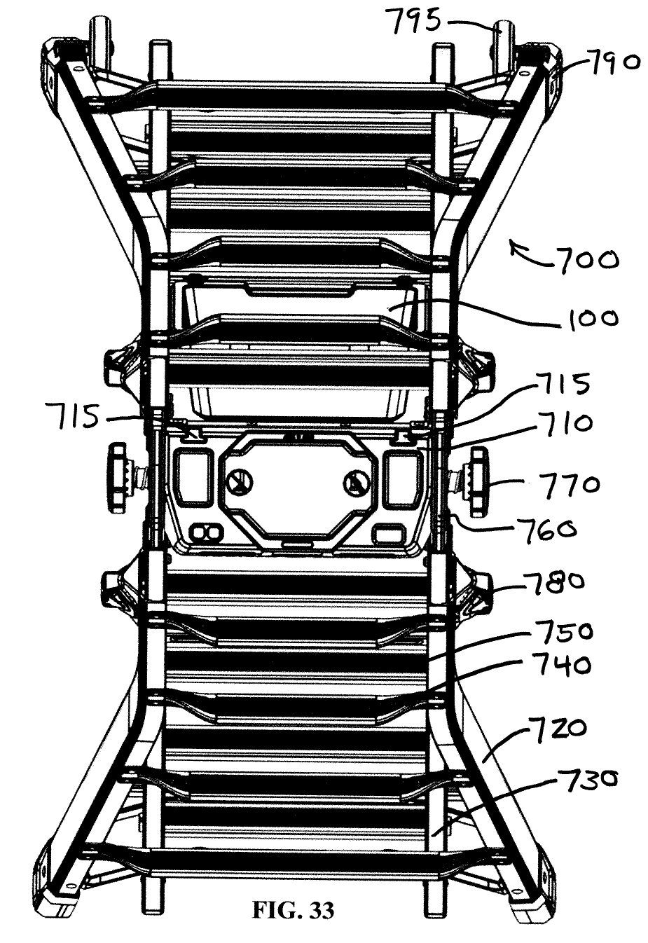

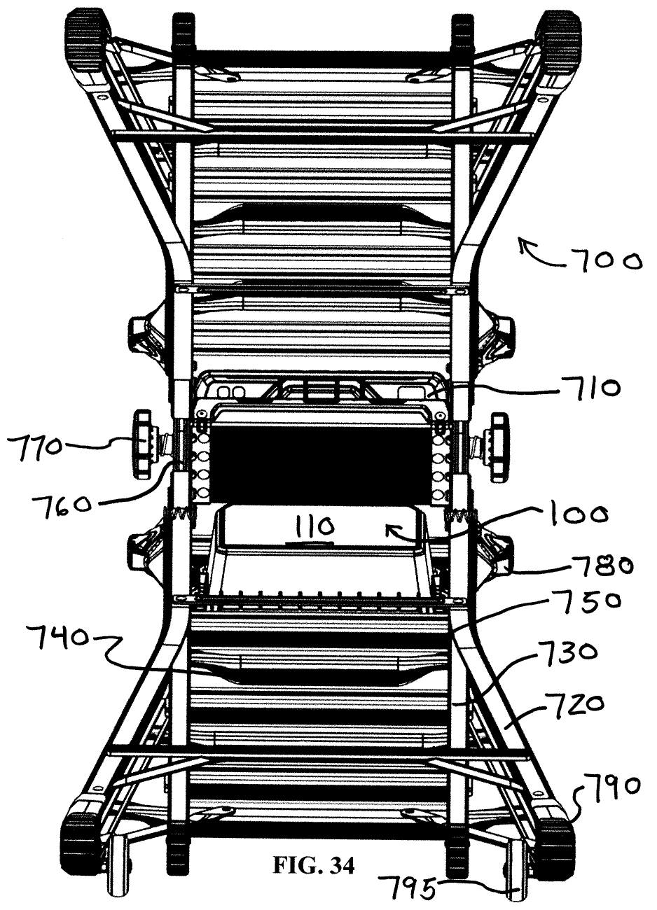

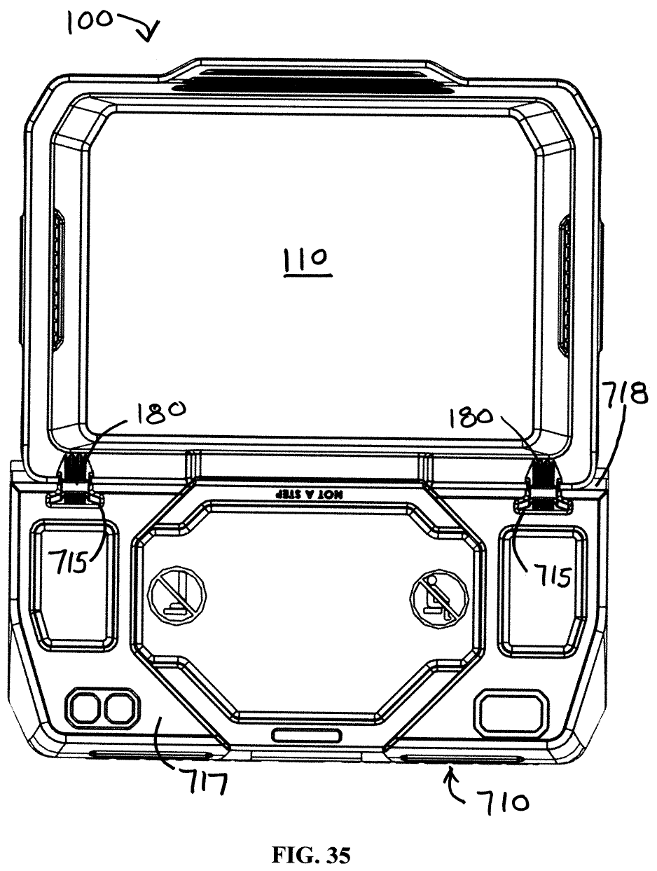

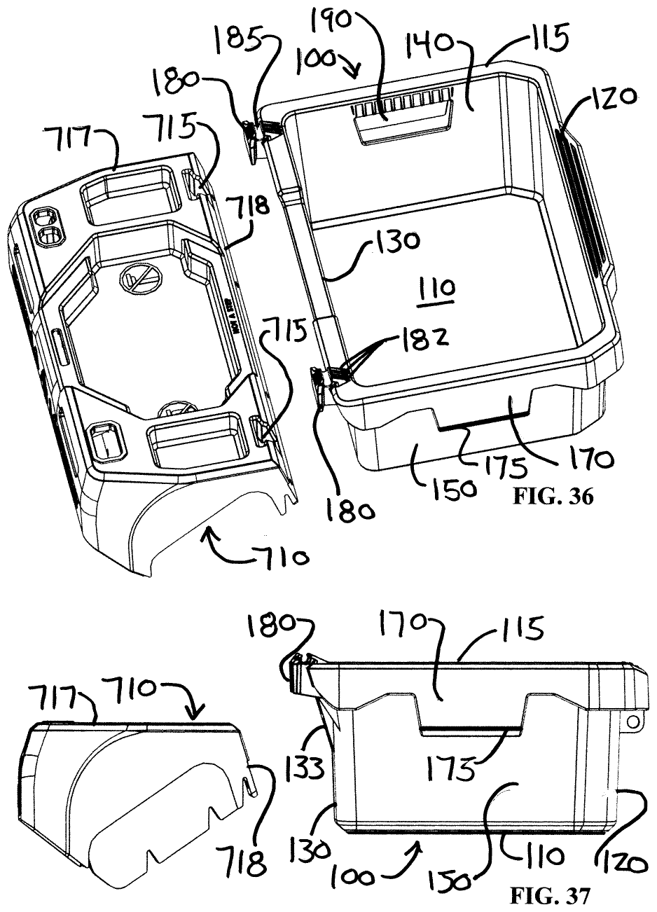

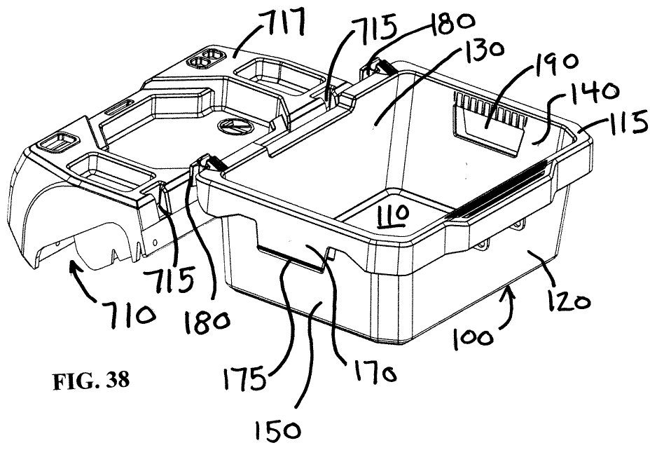

The ladder top cap bucket 100 also includes bucket storage clips 170 that are sized to slidably and securely fit within a respective bucket storage clip receiver slot 805 of a bucket storage clip receiver 800 preferably located on the ladder inner rails 730 (see, FIGS. 21 and 26-27). The storage clip receiver 800 includes a storage clip receiver rear surface. The bucket storage clips 170 each preferably have a clip tab 175 formed in their ends that keep the bucket 100 locked into the ladder inner rails 730 by friction with a bucket storage clip receiver rear surface 802 until selectively unlocked by a user to remove the bucket 100 from the ladder 100.

The ladder top cap bucket 100 may also include side handle orifices 190 in the right side wall 140 or left side wall 150 to provide additional handling options, but preferably includes both. To provide additional strength to the right side wall 140 or left side wall 150 with the addition of handle orifices 190, it is preferred to have handle orifice ribs 195 between the orifices 190 and lip 160 of the right side wall 140 and left side wall 150. The handle orifices 190 also provide means for reaching the bucket storage clips 170 from the interior of the bucket 100 when stored on the ladder 700.

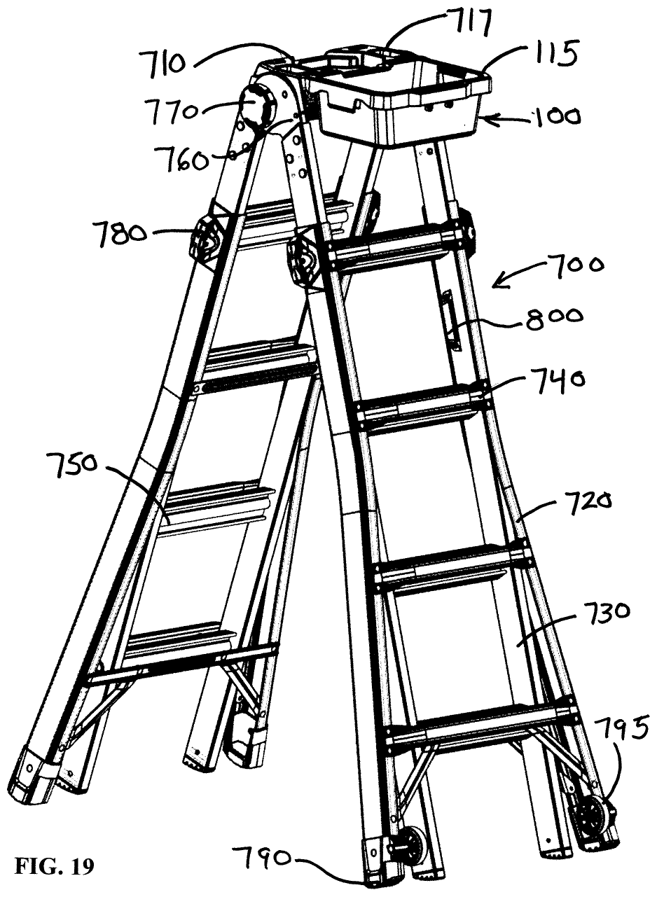

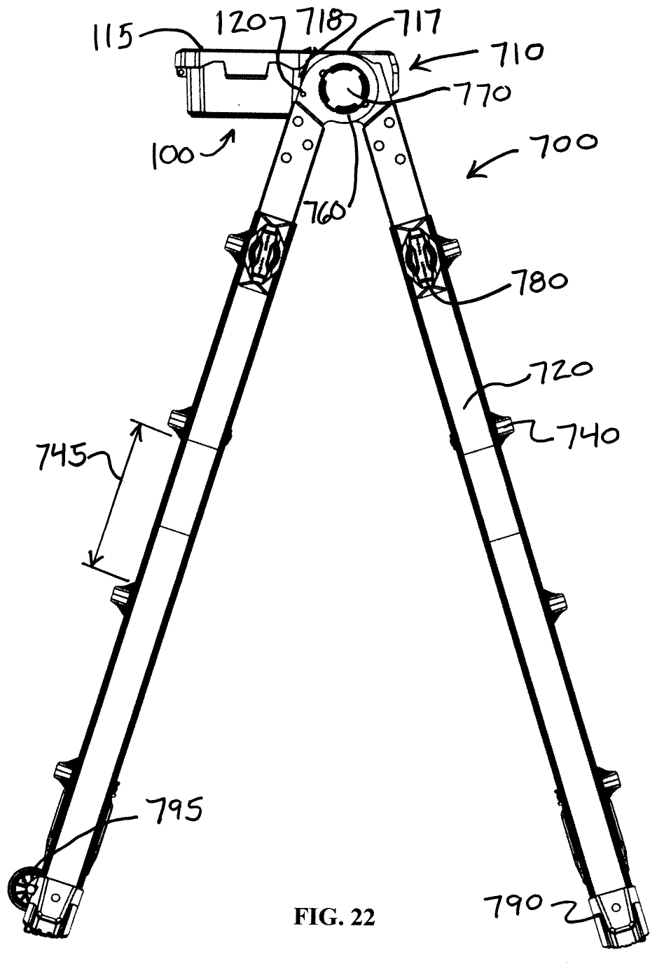

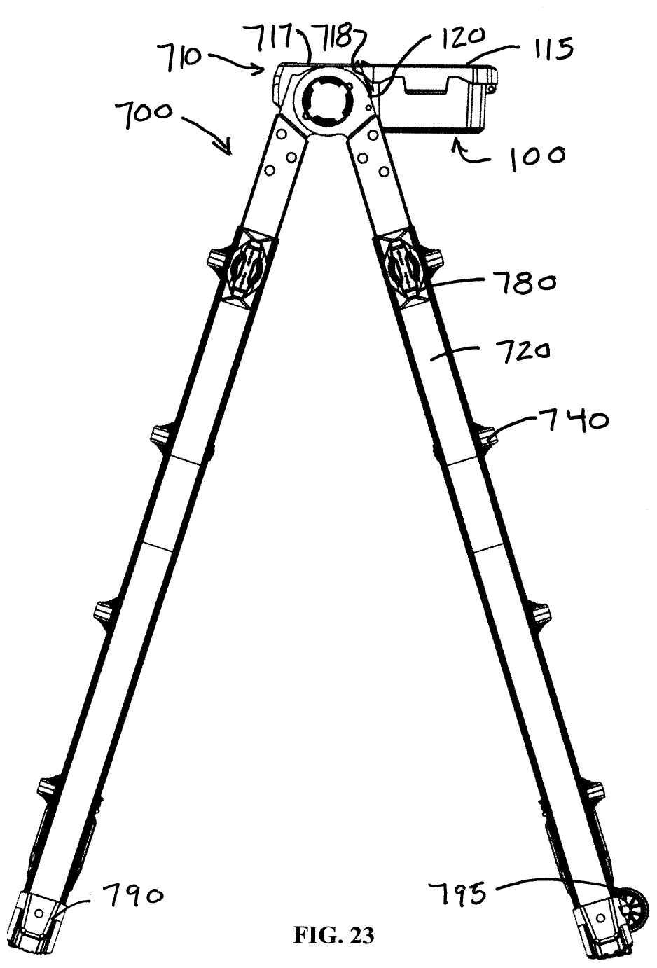

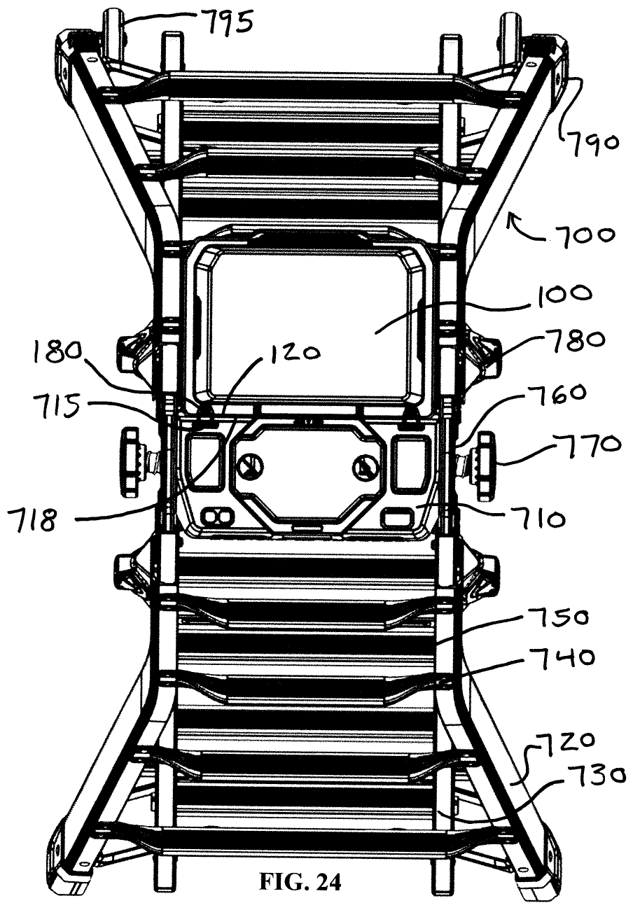

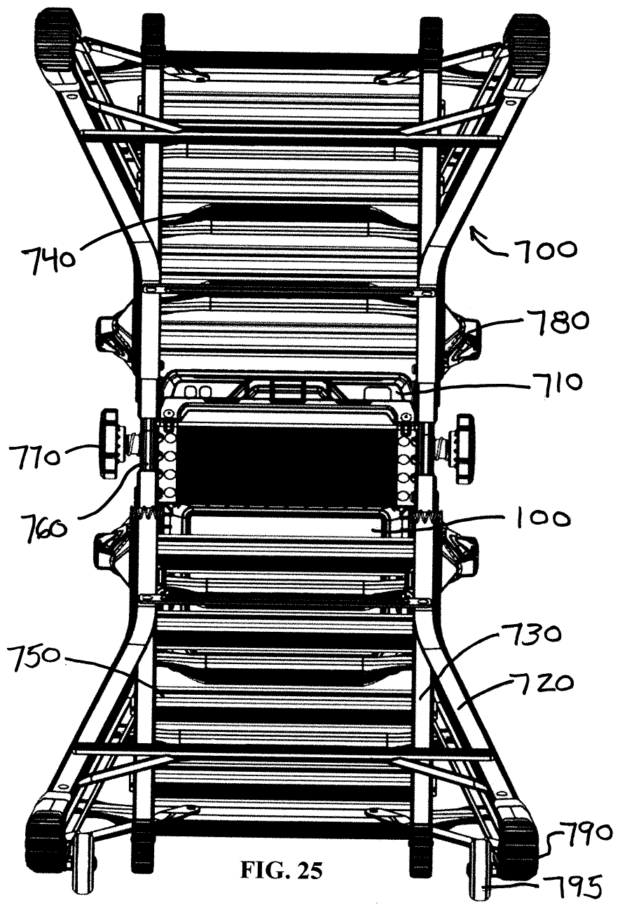

The bucket rear wall 130 includes rear wall supports 133 that provide strength and rigidity to the rear wall 130 as well as provide a mating surface between the bucket 100 and top cap 710 when the bucket 100 is in the use position (FIGS. 19-25). Attachment of the bucket 100 to the top cap 710 is provided by the insertion of bucket use prongs 180 on the rear wall 130 of the bucket 180 within respective bucket use prong receivers 715 located on the top cap upper surface 717 or front wall surface 718. The prongs 180 are sized to slidably and securely fit the prong receivers 715 to firmly hold the bucket 100 in place while in use. The prongs 180 may include prong ribs 182 and form a prong notch 185 that is sized to securely fit to the inner rail rungs 750 in a snapping arrangement. A hanger can then be attached to the hanger orifice 206 to hang the bucket 100 on a higher inner rail rung 750, thus, allowing the bucket 100 to be stored further from the inner rail outer surfer when the ladder 700 is in use. When in the use position, the prongs 180 may extend above the bucket top surface 115 and top cap upper surface 717 as shown in FIG. 23. However, the prong ribs 182 and prong notch 185 are preferably omitted to allow the bucket use prongs 180 to fit entirely within the prong use receivers 715 to provide a flush fit with nothing extending above the top cap upper surface 717 or the bucket top surface 115.

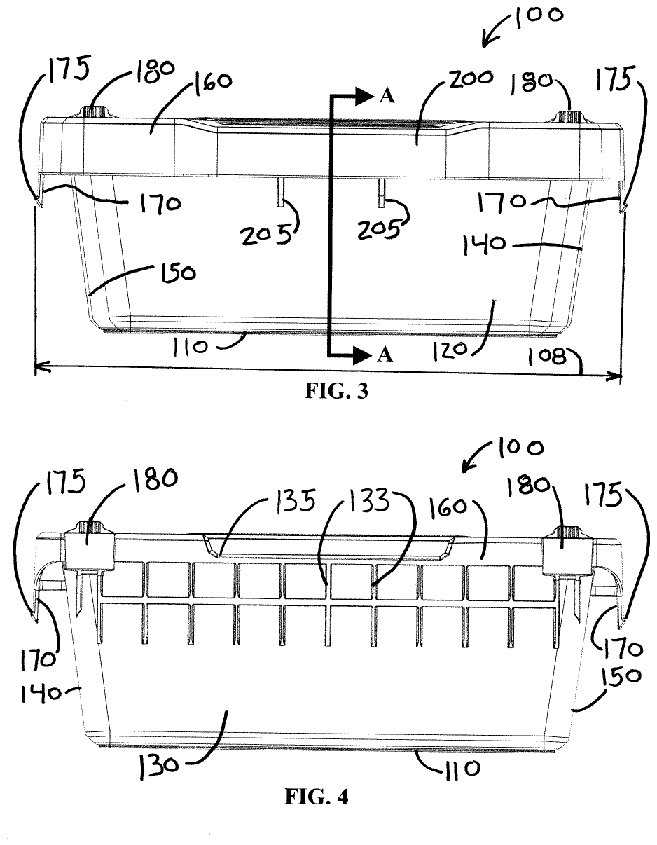

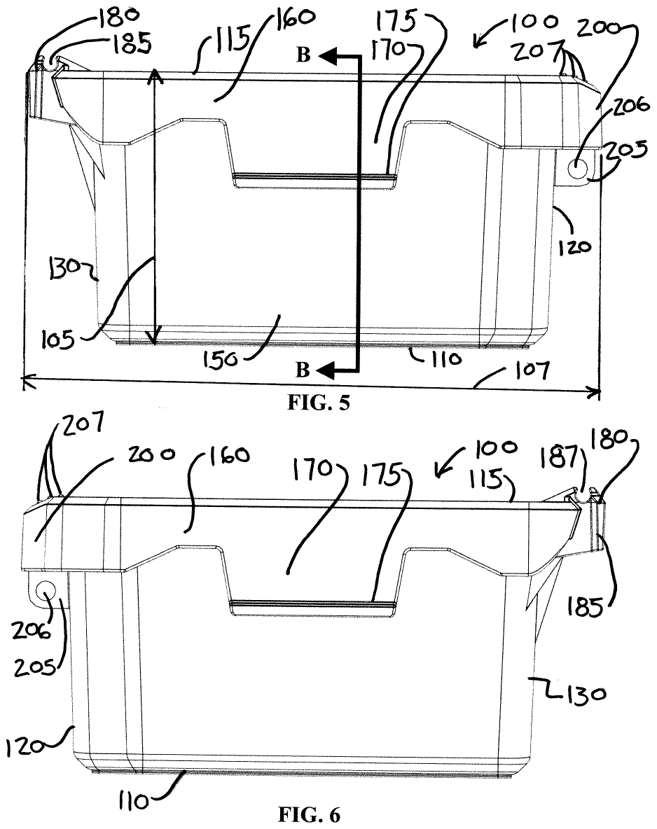

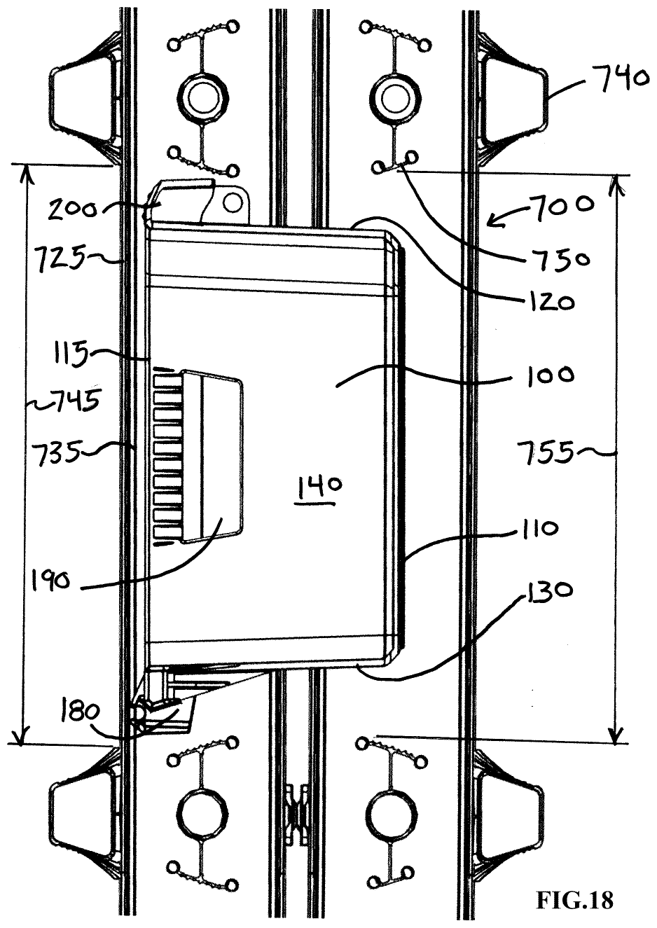

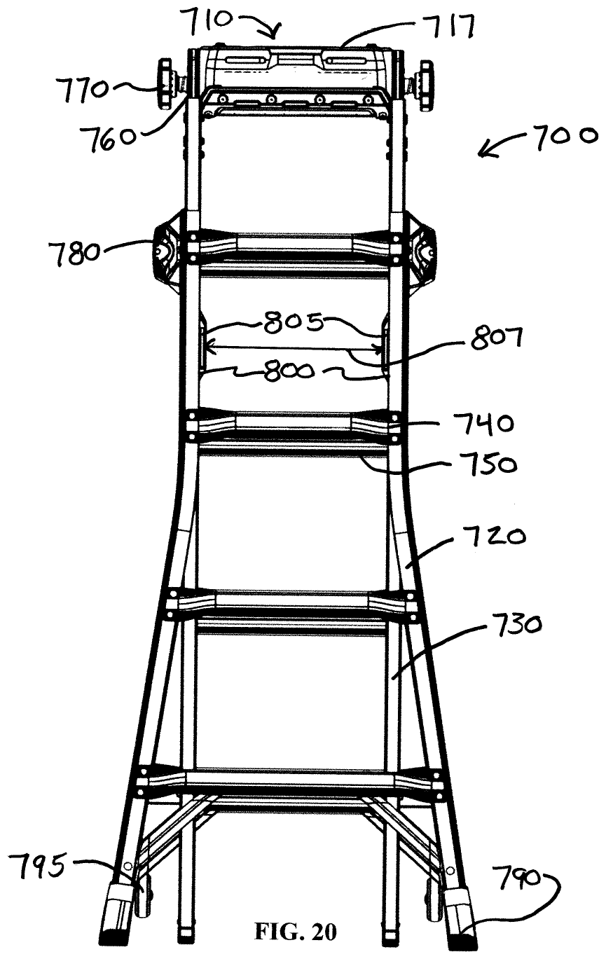

To provide additional strength and stability while the bucket 100 is connected to the top cap 710, the rear wall supports 133 are angled to mate with the top cap front wall surface 718 when the bucket 100 is properly positioned for use. Illustration of the mating angles is best seen in FIG. 37. Typically, but not necessarily, the top cap front wall surface 718 has an angle that is identical to the angle of the rails 720, 730 when the adjustable ladder 700 is in the A-frame position (see, FIG. 23). When the top cap bucket 100 is not being used (in the use position—see, FIGS. 19-25), the present invention allows the bucket 100 to be stored on the ladder 700 in a stored position (see, FIGS. 11-18). As best seen in FIG. 18, the bucket 100 is sized to fit between both the ladder outer rail rungs 740 and ladder rail inner rungs 130 (i.e., the bucket overall width 107 as shown in FIG. 5 is less than the ladder outer rail rung clearance 145 and ladder inner rail rung clearance 155; and the bucket overall length 108 as shown in FIG. 3 is less than the bucket clip clearance as shown in FIG. 20). Additionally, the bucket use prong receivers 715 and bucket storage clips 170 are dimensioned and located so that when the bucket 100 is in the stored position the bucket upper surface 115 does not extend beyond the ladder outer rail outer surface 725 or the ladder inner rail outer surface 755. This not only prevents the bucket 100 from being inadvertently dislodged from the ladder 700, but also allows the outer rail rungs 740 to be used while the bucket 100 is in the stored position. Preferably the bucket 100 is stored (i.e., the storage clip receivers 800 are located) between the uppermost two or three inner rail rungs 750 to allow use of the ladder 700 with the inner rails 730 in longest extension. Furthermore, the bucket depth 105 is such that it less than the combined rail depth 705 (see, FIG. 15) so that the bucket bottom outer surface 112 does not be extend beyond the Rails 720, 730.

Another aspect of the present invention is that the top cap bucket 100 may be left in the use position when the ladder 700 is in the folded orientation (FIGS. 11-18) or the bucket may be left in the stored position when the ladder 700 is in the use extension position (not shown). This feature provides convenience by allowing the ladder 100 to be moved, used, or transported without removing having to move the bucket 100 from the use or stored positions.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A top cap bucket for a multi-position ladder, comprising:
a bucket top surface defined by a front wall, a rear wall, a right side wall, and a left side wall;
a bucket use prong selectively mateable to a bucket use prong receiver on a top cap of a multi-position ladder;
a bucket storage clip selectively mateable to a bucket storage clip receiver on an inner rail of the multi-position ladder; and
a bucket width, bucket length, and bucket depth;
wherein the multi-position ladder comprises:
a pair of inner rails defining an inner rail outer surface, the pair of inner rails connected by a plurality of inner rail rungs defining an inner rail rung clearance;
a pair of outer rails defining an outer rail outer surface, the pair of outer rails connected by a plurality of outer rail rungs defining an outer rail rung clearance;
wherein the bucket width is less than the inner rail rung clearance and less than the outer rail rung clearance; and
wherein when the bucket storage clip is selectively mated to the bucket storage clip receiver, the bucket top surface does not extend beyond the outer rail outer surface or the inner rail outer surface.

2. The top cap bucket of claim 1 wherein the top cap comprises an upper surface and wherein when the bucket use prong is selectively mated to the bucket use prong receiver, the bucket top surface is planar with the top cap upper surface.

3. The top cap bucket of claim 2 wherein the multi-position ladder comprises
two pairs of inner rails connected by a pair of hinges; and
two pairs of outer rails each pair slidable to a respective pair of inner rails and defining a combined rail depth;
wherein the bucket depth does not exceed the combined rail depth.

4. The top cap bucket of claim 3 further comprising a rear wall support; and
the top cap comprises a front wall surface;
wherein the rear wall support and front wall surface are parallel and contacting when the bucket use prong is selectively mated to a bucket use prong receiver.

5. The top cap bucket of claim 4 wherein the top cap front wall surface is parallel to one of the pairs of inner rails.

6. The top cap bucket of claim 5 further comprising a bucket storage clip tab and a bucket storage clip receiver rear surface, the tab making friction contact with the bucket storage clip receiver when the bucket storage clip is selectively mated to the bucket storage clip receiver.

7. The top cap bucket of claim 6 further comprising a bucket side handle orifice in each of the right side wall and left side wall.

8. The top cap bucket of claim 3 wherein the multi-position ladder has a use orientation and a stored orientation, wherein the bucket storage clip is selectively mateable to the bucket storage clip receiver when the multi-position ladder is in either the use orientation or the stored orientation.

9. The top cap bucket of claim 8 wherein the bucket use prong is selectively mateable to the bucket use prong receiver when the multi-position ladder is in either the use orientation or the stored orientation.

10. The top cap bucket of claim 1 wherein the bucket is comprised of injection molded polypropylene.

11. A top cap bucket comprising:
a bucket interior volume defined by a front wall, a rear wall, a right side wall, a left side wall, and a bottom;
a bucket use prong selectively mateable to a bucket use prong receiver on a top cap of a multi-position ladder;
a bucket storage clip selectively mateable to a bucket storage clip receiver on an inner rail of the multi-position ladder;
a bucket rear support configured to be parallel to and contact a top cap front wall; and
a bucket width and a bucket depth.

12. The top cap bucket of claim 11 further comprising a bucket storage clip tab configured to contact a bucket storage clip receiver rear surface on an inner rail of the multi-position ladder.

13. The top cap bucket of claim 12 further comprising a bucket side handle orifice in each of the right side wall and left side wall.

14. The top cap bucket of claim 13 wherein each of the right side wall and left side wall further comprises a lip and orifice ribs, the orifice ribs located between the handle orifice and lip.

15. The top cap bucket of claim 14 further comprising lip ribs.

16. The top cap bucket of claim 15 wherein the bucket is comprised of injection molded polypropylene.

17. The top cap bucket of claim 16 further comprising a bucket front handle.

18. A multi-position ladder, comprising:
two pairs of inner rails defining an inner rail outer surface, each pair of inner rails connected by a plurality of inner rail rungs defining an inner rail rung clearance and the two pairs of rails connected by a pair of hinges;
two pair of outer rails defining an outer rail outer surface, the pair of outer rails connected by a plurality of outer rail rungs defining an outer rail rung clearance and the two pairs of outer rails each pair slidable to a respective pair of inner rails and defining a combined rail depth;
a top cap comprising a front wall surface parallel to one of the pairs of inner rails, an upper surface, and a bucket use prong receiver;
a bucket storage clip receiver mounted to one of the inner rails;
a top cap bucket comprising a bucket use prong selectively mateable to a bucket use prong receiver on a top cap of a multi-position ladder, a bucket storage clip selectively mateable to the bucket storage clip receiver, and rear wall support; and
wherein when the bucket use prong in mated to the bucket use prong receiver, the top cap bucket rear wall support is parallel to and contacting the top cap front wall surface.

19. The multi-position ladder of claim 18 wherein the multi-position ladder has a use orientation and a stored orientation and wherein the bucket storage clip is selectively mateable to the bucket storage clip receiver when the multi-position ladder is in either the use orientation or the stored orientation.

20. The multi-position ladder of claim 19 wherein the bucket use prong is selectively mateable to the bucket use prong receiver when the multi-position ladder is in either the use orientation or the stored orientation.
